(19) United States
(12) Patent Application Publication
(10) Pub. No.: US 2009/0265308 A1
(43) Pub. Date: Oct. 22, 2009

(54) Software and method for teaching, learning, and creating and relaying an account

(76) Inventor: Eric Brown, New York, NY (US)

Correspondence Address: ANDREW F. KNIGHT, 47659 Comer Square, Sterling, VA, 20165, US

(21) Appl. No.: 12/454,338

(22) Filed: May 15, 2009

Related U.S. Application Data
(62) Division of application No. 11/334,100, filed on Jan. 17, 2006.
(60) Provisional application No. 60/671,065, filed on Apr. 14, 2005.

(51) Int. Cl. G06F 7/06; G06F 17/30; G06F 15/16; G06F 17/00

(52) U.S. Cl. 707/2; 707/E17.015; 709/206; 715/234

(57) ABSTRACT

A method of relaying to a user an account regarding characters, where the account includes one embodiment of a branching story, includes: generating a plurality of electronic communicative entities, each expressing a communication of at least one character, and displaying the electronic communicative entities to the user. The method includes prompting the user to choose a branch among a plurality of branches of the branching story, receiving a branch choice of the user, and relaying the account to the user based at least in part on the branch choice. A majority of the electronic communicative entities includes at least one of an email, an instant message, a chat room message, and a web page. The account is substantially completely relayed to the user by the plurality of electronic communicative entities.

### REFERENCE TO RELATED APPLICATION

This application is a divisional application of and claims priority to U.S. patent application Ser. No. 11/334,100, filed Jan. 17, 2006, entitled “SOFTWARE AND METHOD FOR TEACHING, LEARNING, AND CREATING AND RELAYING AN ACCOUNT,” which claims priority to U.S. Provisional Patent Application No. 60/671,065, filed Apr. 14, 2005, entitled, “SOFTWARE AND COMPUTER METHOD FOR EXPERIENTIALLY TEACHING, LEARNING, AND RELAYING AND CREATING AN ACCOUNT,” the disclosures of which are hereby incorporated by reference.

### BACKGROUND OF THE INVENTION

Various devices and media are known for conveying and creating fictional and nonfictional accounts or stories, such as novels, novellas, poetry, and the like, including audio tapes, CDs, CD-ROMs, digital audio files, DVD, and electronic books.

### SUMMARY OF THE INVENTION

There is a need for methods of telling, relaying, writing, and creating fictional and nonfictional stories and accounts in ever more interesting and compelling ways.

In one embodiment, a method of relaying to a user an account regarding characters comprises: generating a plurality of electronic communicative entities, each of the communicative entities expressing a communication of at least one character; and displaying the electronic communicative entities to the user, wherein each of a majority of the electronic communicative entities comprises at least one of an email, an instant message, a chat room message, and a web page, wherein the account is substantially completely relayed to the user by the plurality of electronic communicative entities, and wherein a creation of at least one of the electronic communicative entities is displayed to the user in at least one of real time and a simulation of real time.

In one aspect, the displaying comprises displaying each of the electronic communicative entities to the user in applications corresponding to the type of entities, and wherein the applications comprise at least an email application, an instant message application, and a web browser application. In one aspect, the method is noninteractive, whereby neither the account nor the manner in which the account is relayed to the user is substantially affected by any action of the user.

In another embodiment, a method of relaying to a user an account regarding characters, the account comprising one embodiment of a branching story, comprises: generating a plurality of electronic communicative entities, each of the communicative entities expressing a communication of at least one character; displaying the electronic communicative entities to the user; prompting the user to choose a branch among a plurality of branches of the branching story; receiving a branch choice of the user; and relaying the account to the user based at least in part on the branch choice, wherein each of a majority of the electronic communicative entities comprises at least one of an email, an instant message, a chat room message, and a web page, and wherein the account is substantially completely relayed to the user by the plurality of electronic communicative entities.

In one aspect, the displaying comprises displaying each of the electronic communicative entities to the user in applications corresponding to the type of entities, and wherein the applications comprise at least an email application, an instant message application, and a web browser application.

In one aspect, at least two embodiments of the branching story are substantially different. In one aspect, no two embodiments of the branching story are substantially different.

In one aspect, the method further comprises: prompting a second user to choose a branch among a plurality of branches of the branching story; receiving a branch choice of the second user; and relaying the account to the user and second user based at least in part on the branch choice of the second user.

In one aspect, prompting the user to choose the branch comprises prompting the user to draft and address an electronic communicative entity to at least one of the first and second characters, the electronic communicative entity comprising at least one of an email, an instant message, and a chat room message.

In one aspect, for each branch, the user is prompted to choose the each branch at a specified point in a timeline of the account. In one aspect, for at least one branch, the user is prompted to choose the at least one branch at a plurality of points in a timeline of the account.

In another embodiment, a method of relaying to a user an account regarding characters comprises: generating a plurality of electronic communicative entities, each of the communicative entities expressing a communication of at least one character; and displaying the electronic communicative entities to the user; wherein each of a majority of the electronic communicative entities comprises at least one of an email, an instant message, a chat room message, and a web page, wherein the account is substantially completely relayed to the user by the plurality of electronic communicative entities, and wherein the account is not substantially affected by any action of the user, but the manner in which the account is relayed to the user is substantially affected by actions of the user throughout the relaying of the account.

In one aspect, the account has a timeline and the electronic communicative entities correspond to specified points in the timeline, and wherein the displaying comprises displaying the electronic communicative entities in any order selected by the user.

In one aspect, the displaying comprises displaying each of the electronic communicative entities to the user in applications corresponding to the type of entities, and wherein the applications comprise at least an email application, an instant message application, and a web browser application.

In one aspect, the method further comprises receiving a plurality of instructions from the user to provide further information of the account, wherein each of the plurality of instructions comprises an electronic communicative entity addressed to at least one of the first and second characters.

In one aspect, if the plurality of instructions is fewer in number than a threshold, then that portion of the account relayed to the user comprises substantially less than a whole of the account.

In another embodiment, a method of relaying to a user an account regarding characters comprises: generating a plurality of electronic communicative entities, each of the communicative entities expressing a communication of at least one character; and displaying the electronic communicative entities to the user; wherein each of a majority of the electronic communicative entities comprises at least one of an email, an instant message, a chat room message, and a web page, wherein the account is substantially completely relayed to the user by the plurality of electronic communicative entities, and wherein at least one of the account and a manner in which the account is relayed to the user is randomly altered.

In one aspect, the displaying comprises displaying each of the electronic communicative entities to the user in applications corresponding to the type of entities, and wherein the applications comprise at least an email application, an instant message application, and a web browser application.

In one aspect, the method is noninteractive, whereby neither the account nor the manner in which the account is relayed to the user is substantially affected by any action of the user.

In another embodiment, a method of relaying to a user an account having a timeline comprises: prompting the user to choose to perceive the account according to exactly one of: a rate selected by the user; and a rate corresponding to the timeline; receiving a choice of the user; and relaying the account to the user based at least in part on the choice of the user.

In one aspect, the account is substantially completely relayed to the user via a plurality of electronic communicative entities. In one aspect, each of a majority of the electronic communicative entities comprises at least one of an email, an instant message, a chat room message, and a web page. In one aspect, the method is noninteractive, whereby neither the account nor the manner in which the account is relayed to the user is substantially affected by any action of the user.

In another embodiment, a method of relaying to a user an account regarding at least first and second characters comprises: prompting the user to choose to perceive the account from the perspective of at least one of the first character, the second character, a friend of the first character, and a friend of the second character; receiving a choice of the user; and relaying the account to the user based at least in part on the choice of the user, wherein the account is substantially completely relayed to the user via a plurality of electronic communicative entities, and wherein each of a majority of the electronic communicative entities comprises at least one of an email, an instant message, a chat room message, and a web page.

In one aspect, if the user chooses to perceive the account from the perspective of a friend of the first or second character, the method further comprises: providing the user with a list of sets of characters; prompting the user to choose at least one of the sets of characters; receiving a choice of the user; and relaying the account to the user based at least in part on the choice of the user of at least one of the sets of characters, wherein for each of the sets of characters, that portion of the account relayed to the user from the perspective of friends of the characters in the each of the sets of characters comprises substantially a whole of the account.

In one aspect, if the user chooses to perceive the account from the perspective of a friend of the first or second character, the method further comprises: prompting the user to choose at least another character; receiving a choice of the user; and relaying the account to the user based at least in part on the choice of the user of at least another character.

In one aspect, the method is noninteractive, whereby neither the account nor the manner in which the account is relayed to the user is substantially affected by any action of the user.

In another embodiment, a method of relaying to a user an account regarding characters comprises: generating a plurality of electronic communicative entities, each of the communicative entities expressing a communication of at least one character; displaying the electronic communicative entities to the user; providing a search command to the user; receiving a search instruction from the user; searching the electronic communicative entities based at least in part on the search instruction; and displaying to the user at least one electronic communicative entity that satisfies the search instruction, wherein each of a majority of the electronic communicative entities comprises at least one of an email, an instant message, a chat room message, and a web page, and wherein the account is substantially completely relayed to the user by the plurality of electronic communicative entities.

In one aspect, the method further comprises: providing a change options command to the user; receiving an options instruction from the user; and altering at least one of background color and text font, color, and size of an electronic communicative entity based at least in part on the options instruction.

In one aspect, the method further comprises: providing a sort command to the user; receiving a sort instruction from the user; and sorting at least a plurality of the electronic communicative entities based at least in part on the sort instruction.

In another embodiment, a method of creating an account regarding characters comprises: providing an electronic template for entering information; prompting a user to compose a plurality of electronic communicative entities and to enter the electronic communicative entities via the template, each electronic communicative entity representing an electronic communication from one of the characters to at least one other of the characters; and prompting the user to arrange the plurality of electronic communicative entities in an order, wherein each of a majority of the electronic communicative entities represents at least one of an email, an instant message, and a chat room message, and wherein the account can be substantially completely relayed to a reader by displaying to the reader the plurality of electronic communicative entities in the order.

In one aspect, the method further comprises: for each electronic communicative entity, prompting the user to select whether the electronic communicative entity represents an email, an instant message, or a chat room message.

In one aspect, the method further comprises: prompting the user to create a plurality of branches, whereby the account comprises one embodiment of a branching story; for each electronic communicative entity, prompting the user to assign the electronic communicative entity to at least one of the plurality of branches.

In one aspect, the method further comprises: for each electronic communicative entity, prompting the user to determine whether or not displaying of the electronic communicative entity to the reader requires an action of the reader.

In one aspect, the method further comprises: prompting the user to indicate character perspective options, whereby the account may be relayed from the perspectives of at least two different characters; and for each electronic communicative entity, prompting the user to assign the electronic communicative entity to at least one character perspective option.

The present invention also includes a computer-readable medium encoding computer-executable instructions for performing any of the stated methods.

The present invention also includes a method of creating an account, comprising configuring a machine-readable medium to cause a machine to perform any of the stated methods.

The present invention also includes a method of teaching, comprising: performing any of the stated methods; and prompting the user to answer a plurality of quiz questions regarding the account.

The present invention also includes a computer network, comprising: a central processor; a plurality of remote processors remotely connected to the central processor via an information line; and a computer-readable medium encoding computer-executable instructions for performing any of the stated methods, wherein the generating a plurality of electronic communicative entities comprises generating at least a portion of the electronic communicative entities by the central processor and generating at least a portion of the electronic communicative entities by a remote processor.

### BRIEF DESCRIPTION OF THE DRAWINGS

FIG. 1 shows a computer screen shot according to one embodiment of the present invention.

FIG. 2 shows a computer screen shot according to one embodiment of the present invention.

FIG. 3 shows a computer screen shot according to one embodiment of the present invention.

FIG. 4a shows a computer screen shot according to one embodiment of the present invention.

FIG. 4b shows a computer screen shot according to one embodiment of the present invention.

FIG. 5 shows a computer screen shot according to one embodiment of the present invention.

FIG. 6 shows a schematic diagram of a computer network.

### DETAILED DESCRIPTION

In one embodiment, the present invention is addressed to devices and methods for providing information (such as telling a fiction or nonfiction story) via a collection of communicative entities (e.g., communicative items or communicative interactive electronic means), such as emails, instant messages, voicemails, websites, chat room conversations, pager messages, and so forth. The story may include traditional narration, but in one embodiment, the majority or all of the story is told via the collection of the communicative entities.

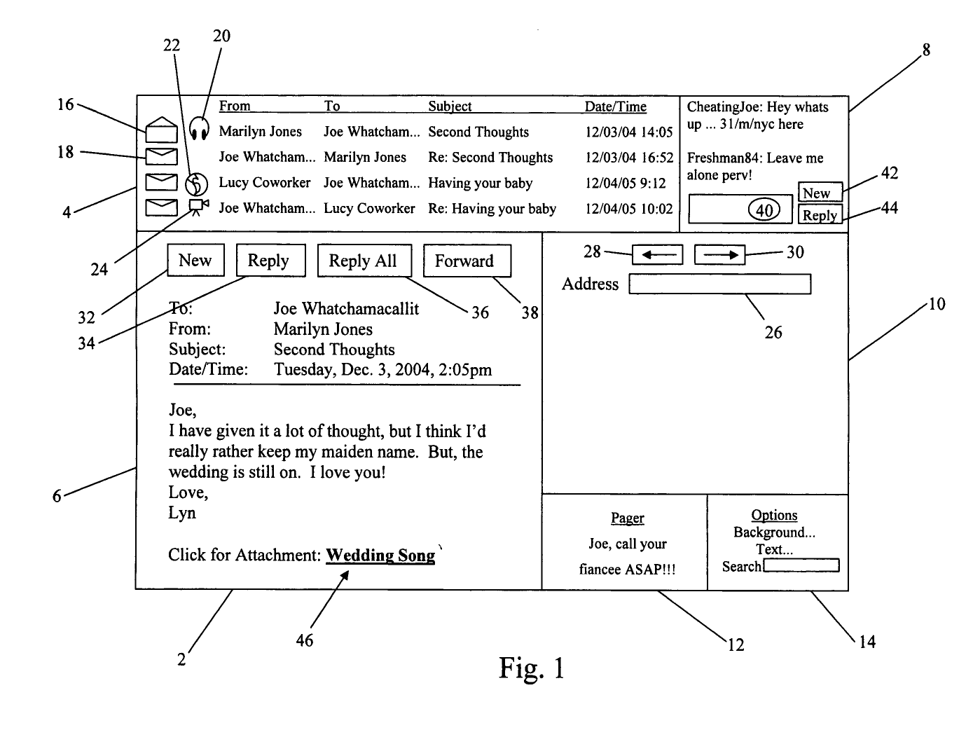

Referring now to FIG. 1, a computer screen shot 2 comprises an email list window 4, an email text window 6, an instant message (“IM”) window 8, a web browser window 10, a pager window 12, and an options window 14. The computer screen shot 2 may consist of the entire screen shot of a computer screen, or may comprise an application window within a computer screen shot. The computer screen shot 2 is the creation of an application software configured to execute the method(s) described herein.

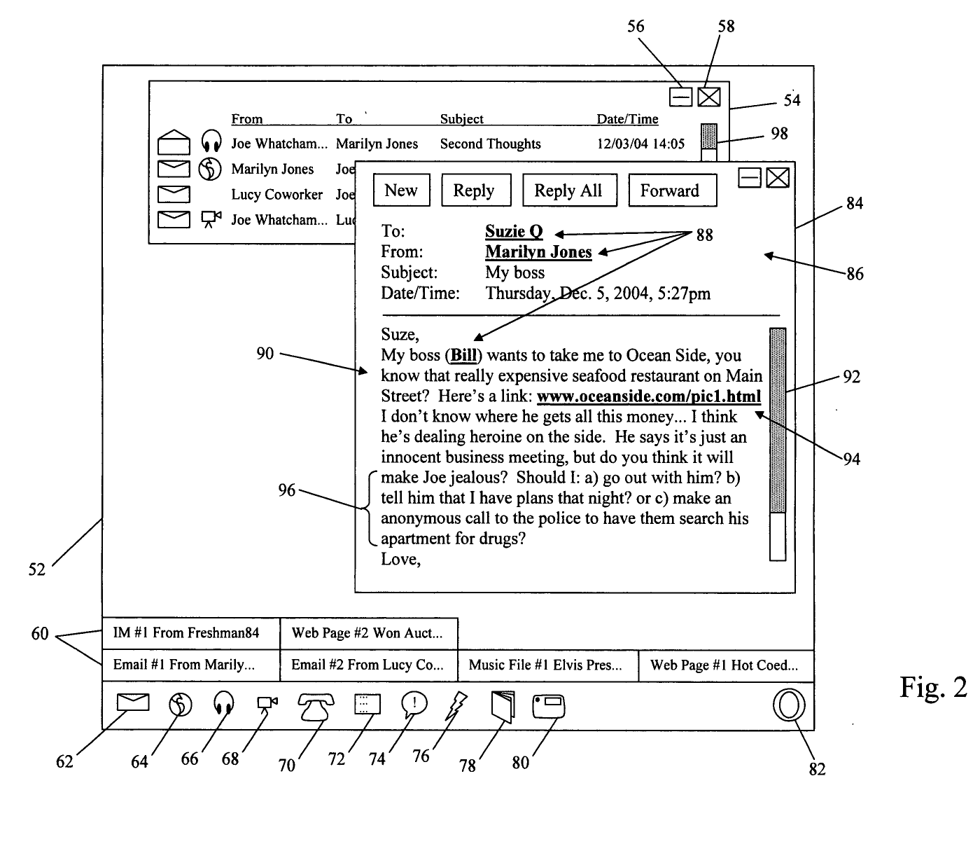

The email list window 4 shows information for a plurality of emails, such an open symbol 16 for an opened (i.e., previously or currently read) email, an unopened symbol 18 for an unopened (i.e., unread) email, and a symbol corresponding to the kind of attachment (if any) to the email, such as a sound or music attachment 20, a web link attachment 22, and a video or movie attachment 24. The email list window 4 further shows for each email attributes such as who the email is from (“From”), who the email is addressed to (“To”), what is the subject of the email (“Subject”), and the date and time that the email was sent (“Date/Time”). The email list window 4 in FIG. 1 shows four emails, but more than four emails may be displayed by using a scroll bar (e.g., the scroll bar 92 shown in FIG. 2), as understood by one of ordinary skill in the art. Emails may include many other kinds of attachments than the three shown in FIG. 1 (such as another email, a voicemail, an IM link or conversation, a chat link or conversation, etc.), and symbols corresponding to such possible attachments could be shown next to attaching emails.

The email text window 6 includes information corresponding to “To,” “From,” “Subject,” “Date/Time,” and the text of the email message, as well as any links and/or attachments included in the email message, such as music attachment 46. When the user clicks on the music attachment 46, the corresponding music plays via the computer's speakers or headphones. (The screen shot 2 may or may not include a further sound application window, not shown, which displays the sound or music being played and allows the user to control the sound, such as via “play,” “pause,” “stop,” “rewind,” and “repeat” buttons, and the like.)

In one embodiment, such as an interactive embodiment (discussed later), it further includes a new button 32, which allows the user to compose a new email message upon pressing (i.e., clicking on with a mouse) the button, a reply button 34 which allows the user to reply to the sender of the current email message upon pressing the button, a reply all button 36, which allows the user to reply to the sender and all other recipients of the current email message upon pressing the button, and a forward button 38, which allows the user to forward the current email message to another character upon pressing the button. The email text window 6 in FIG. 1 displays an email received by Joe Whatchamacallit from Marilyn Jones.

The IM window 8 displays an IM conversation (which, if its length exceeds the size of the IM window 8, may include a scroll bar to allow the user to scroll through the conversation), a text entrance box 40, which allows the user to enter text to send to a character, a new button 42, which allows the user to create and/or send a new IM to a character by pressing the button, and a reply button 44, which allows the user to reply to an IM received from a character by pressing the button. The IM window 8 in FIG. 1 displays a brief conversation between CheatingJoe and Freshman84. “CheatingJoe” is a fictitious screen name which may, in one embodiment, be held and used by the same Joe Whatchamacallit to which the email in email text window 6 is addressed.

The web browser window 10 includes an address box 26, which allows a user to enter a web address into the box to access a corresponding (real or fictitious) world wide web page. Alternatively or in addition the user may click a link in an email that opens the web browser window 10 and directs the browser to the linked webpage. The window 10 also includes back button 28 and forward button 30, which allows a user to navigate between web pages already visited. The pager window 12 displays pager messages received by one or more characters in the story.

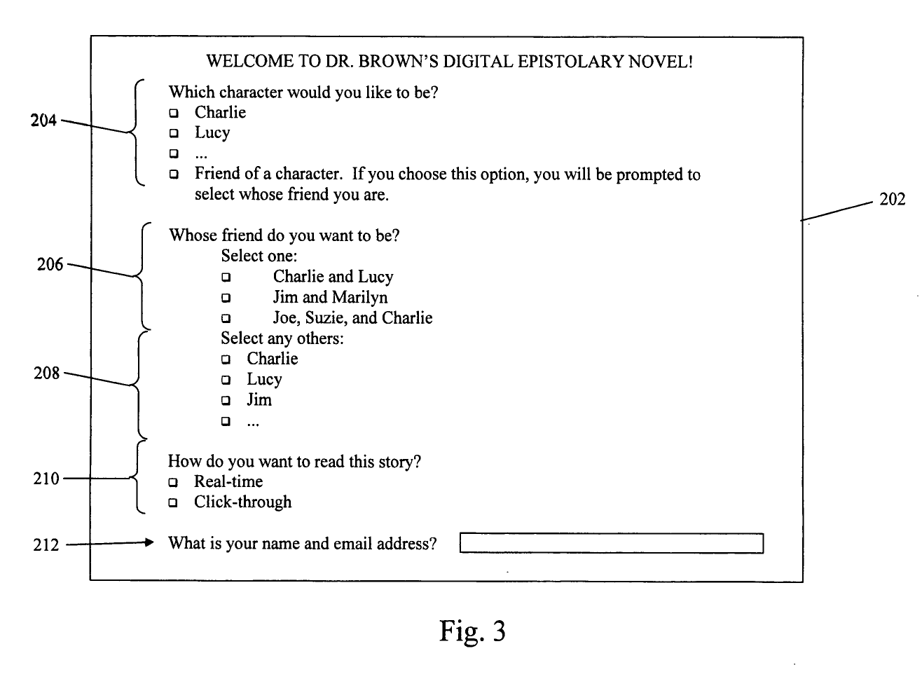

The options window 14 includes options that a user may browse and select regarding the software, such as background colors and designs, text fonts, colors, and sizes, screen layout and size, how the story is told (e.g., “real-time” or “click-through,” to be described later), what character or characters' friend the user is acting as (to be described more with respect to FIG. 3), etc. These examples are not exhaustive; any feature of the executed application or told story that can be modified by a user may or may not be modified in the options window 14. Further, the options window 14 may include a “search” feature that allows a user to search through the communicative entities for specific search terms or phrases. For example, if the user is interested in re-reading emails regarding a particular interaction between Joe and Lucy, the user may enter a relevant search term in the “search” box to help locate and identify these emails, which the user may subsequently click on in the email list window 4 to view the corresponding email(s).

In the embodiment shown in FIG. 1, the software is self-contained, requiring only the execution of the software on an appropriate machine or computer. In other words, the application creates a virtual reality, in that no actual emails are sent or received to or from another person, no actual world wide web sites are viewed, no actual IMs are sent or received to or from another person, no actual voicemails are sent or received to or from another person, and so forth. The software includes all of the information, text, messages, communicative entities, web pages, and so forth, necessary to tell the story as intended by the storyteller.

In the embodiment shown in FIG. 1, the email list window 4 includes all emails sent throughout the story, and the user may click on the emails to open them at his will—e.g., in any order or progression. Alternatively, the software may allow the user to open emails only in chronological order, or may simply prohibit skipping ahead in the story past unopened emails (but may allow the re-reading or re-opening of previously opened emails). In another embodiment, the email list window 4 lists only emails sent on a given day, week, month, or other time period, and the user must click on a desired time period (not shown) to allow the email list window 4 to be populated with emails sent during the desired time period. For example, the in the case of a story spanning five weeks, the time periods may be broken into five weeks, and within each week seven days. The user therefore may choose from among 35 desired time periods (here, days) in which email messages were “sent” by characters by first choosing a desired week and second by choosing a desired day within the week.

In one embodiment, the software is not interactive—i.e., does not allow the user to interact with the characters in the story. In one such non-interactive embodiment, the user may be a voyeur, in that the user is capable of reading emails not addressed to the user. One non-interactive embodiment of the present invention will now be described with reference to FIG. 1. (However, the user may also be a voyeur in an interactive embodiment, also.)

A user clicks on a first email in the email list window 4, such as the first shown email (i.e., from Joe Whatchamacallit). The email “opens” in the email text window 6, as shown, which text the user reads. The user then clicks on the next email in the email list window 4 (i.e., from Marilyn Jones). After reading that email, the user then clicks on the next email in the email list window 4 (i.e., from Lucy Coworker), and reads that email. The user continues this process until all emails have been opened and read in progression, wherein the story has been completely told via email messages. Such is a voyeur embodiment because the user is reading (presumably private) emails sent between senders and recipients to which the user is not an explicit party. In other words, the user is reading the emails of all relevant parties.

In one or more emails, attachments may be included (e.g., attachments 20, 22, 24) which may immediately open upon the user opening the attaching email, or may include links within the email (e.g., sound attachment 46, or link 94 shown in FIG. 2) which, once clicked, open the attachments. Such attachments may, of course, further or be part of the storyline. For example, in FIG. 1, the first email message includes a sound attachment 46 which link, once clicked, plays a wedding song through the computer's speakers. The wedding song furthers the storyline by demonstrating Marilyn's devotion and readiness to marry Joe. The third email, from Lucy to Joe, has a subject of “Having your baby,” and may contain text indicating that Lucy is going to have Joe's child. The third email also includes a web link attachment 22, which may, for example, be a link to Lucy's world wide web page (which may be fictitious) in which she displays ultrasound pictures of her unborn baby. The fourth email includes a video attachment 24, which may comprise a “webcam” movie, made by Joe, of Joe talking to Lucy. In these cases, the attachments further the storyline and/or add interesting, fun, or relevant details to the storyline. Other conceivable email attachments are within the scope of the present invention.

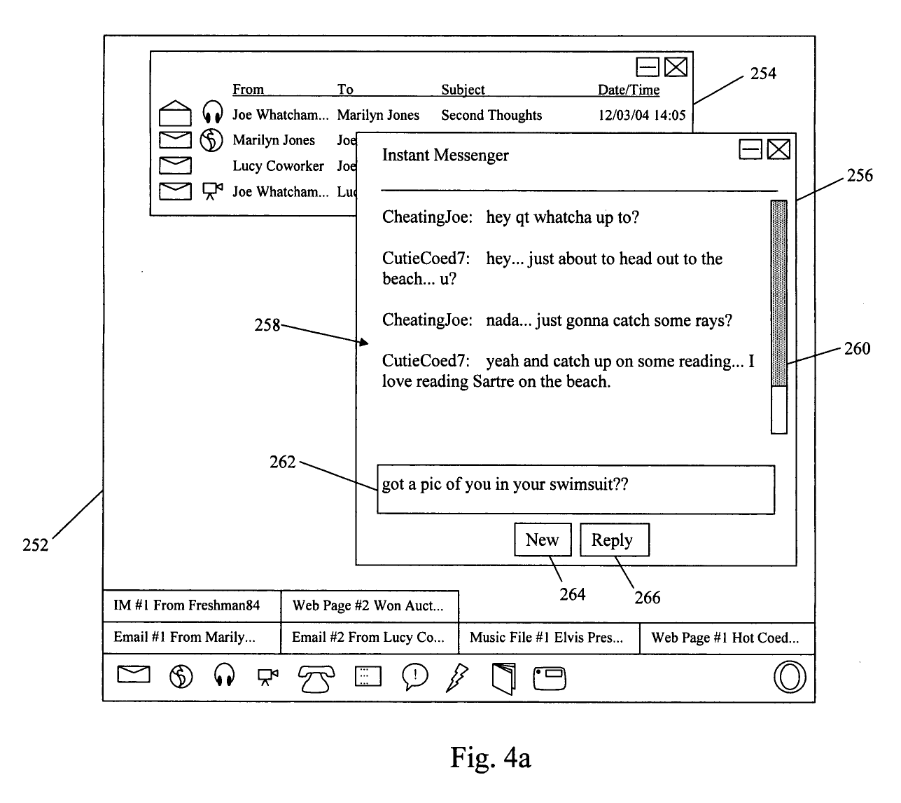

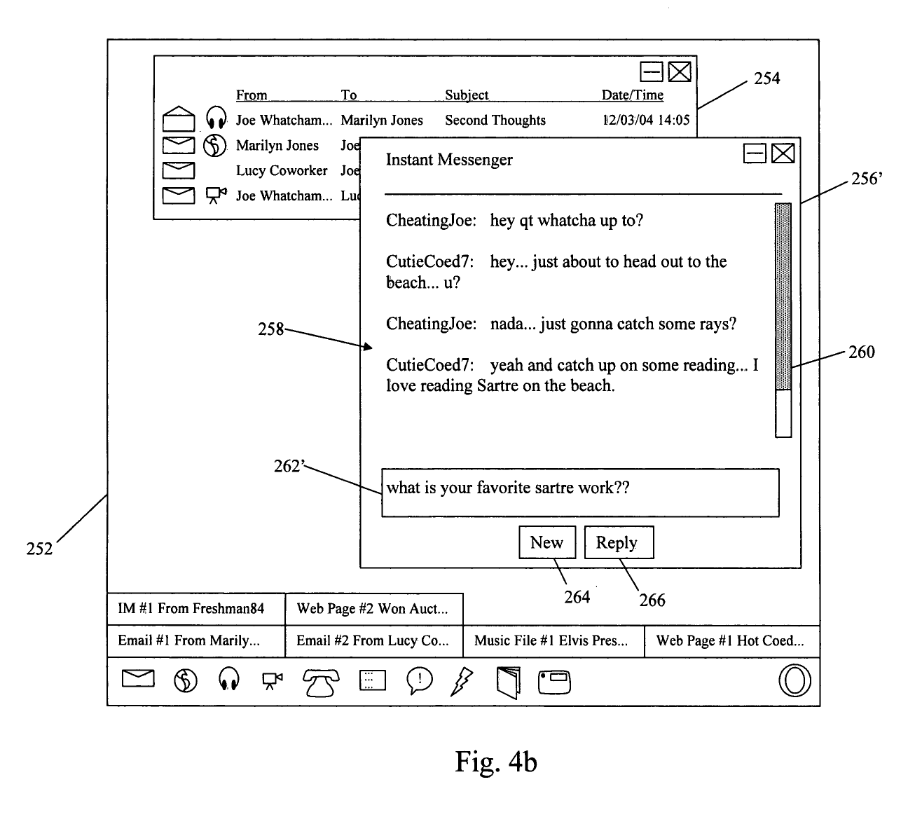

In addition to emails and/or attachments as communicative entities for providing information to further the storyline, IMs may appear in the IM window 8 to show conversations between characters. For example, one or more of the entities displayed in the email list window 4 may not actually be emails, but may comprise entities such as IM conversations, voicemails, pager messages, chat conversations, and the like. For example, assume between the second and third emails appeared an IM entity which, once clicked by the user, caused the IM window 8 to display an IM conversation. The IM conversation could be presented all at one time, in which case the user could scroll through the conversation at her own leisure (using a scroll bar, not shown, unless the conversation is too short to necessitate a scroll bar). Alternatively, the IM conversation could be displayed in “real” time. In one such real-time embodiment, the messages appear whole but one at a time, with a pause of perhaps a few seconds or minutes between messages. In another real-time embodiment, the IM window 8 displays the messages as they are “typed” by the characters, allowing the user to see where a character is hesitating, deleting, and so forth, in typing their respective IMs. This real-time embodiment could apply to any or all of the communicative messages described herein, and a specific embodiment will be described with regard to an IM conversation in FIGS. 4a and 4b.

The email list window 4 is simply one way of organizing and allowing a user to access the various communicative entities. Of course, any manner available to one of ordinary skill in the art is within the scope of the present invention. Ultimately, the story is presented in a series of communicative entities (which may or may not be presented in chronological order) between characters, such as emails, IMs, voicemails, and so forth, and any method of allowing a user to read, hear, or otherwise perceive these entities so as to be told the story is within the scope of the present invention.

Referring now to FIG. 2, a computer screen shot 52 comprises an email list window 54, an opened email 84, a series of minimized applications and/or communicative entities 60, and a plurality of application open buttons 62-82. The email list window 54 may be similar to that shown in FIG. 1, except that it is movable within screen shot 52, its size changeable within screen shot 52, and includes a minimization button 56, which allows the email list window 54 to be “minimized” into a small readily-accessible tab (such as minimized communicative entities 60) shown at the bottom of the screen shot 52, and an application close button 58, which allows the email list window 54 to be closed until it is reopened by pressing the appropriate email application open button 62. The email list window 54 also includes a scroll bar 98 to allow the user to scroll through the email entries to select the email(s) that she desires to open and read. As understood by one of ordinary skill in the art, when a minimized tab 60 is clicked, the corresponding application and/or entity will “maximize” into a larger window (e.g., similar to the window for email 84), in which the application and/or entity may be manipulated or used by the user. The minimized communicative entities 60, in FIG. 2, show an opened email from Marilyn, an opened email from Lucy, an Elvis song loaded into the sound/music application, a “Hot Coeds” website loaded onto the web browser, an opened IM conversation from Freshman84, and a “won auction” website loaded onto the web browser.

Email 84 may include similar minimization and application close buttons. It should be understood that an application (e.g., the email application, the sound/music application, the video application, etc.) is not, per se, a communicative entity (which is the communication expressed via the application). However, both applications and entities may be minimized, maximized, closed, and opened. For example, the minimized tab 60 entitled “Music File #1 Elvis Pres . . . ”, when maximized, may maximize the sound/music application, in which is loaded an Elvis Presley song (a communicative entity). The user may then play the Elvis Presley song by pressing/clicking “play” on the sound/music application (not shown). However, the sound/music application may be loaded or maximized by itself, without any entity, such as by pressing the sound/music application open button 66 (discussed later), or the entity if already loaded in the application may be minimized or closed out of the sound/music application.

The email list window 54 may include the relevant chronology for the story. For example, as discussed with respect to FIG. 1, the entries may be listed in the order in which the storyteller wishes to tell the story, and the entries may include non-email entries, such as IM entries wherein, upon the user clicking such entries, the IM window 8 is populated with IM conversation(s). However, to preserve the realistic appearance of the program and the screen shot 52 (FIG. 2), email list window 54 may or may not include only email entries. If the story includes non-email communicative entities that the storyteller does not wish to embed within email messages, and if the storyteller does not prefer to include all non-email entries in the email list window 54, then the software may include another application or information that informs the user in which order to perceive each communicative entry. For example, the screen shot 52 may include a clickable list of entries corresponding to communicative entities, which list, if clicked in the proper order, result in the proper display of the corresponding entities to tell the story. Alternatively or in addition, the communicative entities may be provided to the user on a timed basis (e.g., in a “real-time” version of the present invention), in which no explicit chronology is necessary because the user is fed each entity one at a time, and in the proper order.

The software may include various applications which are accessible via buttons 62-82 in the screen shot 52, including: an email application open button 62, a web browser open button 64, a sound/music application open button 66, a video application open button 68, a voicemail application open button 70, a chat room application open button 72, an IM application open button 74, a special features application open button 76, a dictionary/translator application open button 78, a pager application open button 80, and an options application open button 82.

The email application opens (thus showing the email list window 54) upon clicking the email application open button 62, and allows the user to open (and read), compose, reply, reply all, and forward emails. The email application may be similar in form and/or function to Microsoft Outlook™. The web browser application opens upon clicking the web browser open button 64, thus allowing the user to visit Internet web sites (real (via an actual connection to the Internet) or fictional (created by and internal to the software)). The web browser application may be similar in form and/or function to Microsoft Internet Explorer™ or Netscape Navigator™. The sound/music application opens upon clicking the sound/music application open button 66, thus allowing the user to play, pause, stop, fast forward, reverse, and rewind digital sound files. The user may also possibly record digital sound files by using a microphone connected to the computer. The sound/music application may be similar to a digital Apple iPod™ software program. A video application opens upon clicking the video application open button 68, thus allowing the user to play, pause, stop, fast forward, reverse, and rewind digital video files. The user may also possibly record digital video files by using a video recorder (e.g., a webcam) connected to the computer. A voicemail application opens upon clicking the voicemail application open button 70, thus allowing the user to play, pause, stop, skip, repeat, and possibly record (via a microphone connected to the computer) voicemails. A chat room application opens upon clicking the chat room application open button 72, thus allowing the user to enter and join into (such as by reading and/or entering text) a chat room conversation among characters. A chat room is a virtual room in which more than two people may simultaneously meet and “chat” with typed messages. Usually a theme is associated with chat rooms (e.g., “People Who Love Chess”), so that like-minded people may meet and chat in a chat room. The chat room application may be similar to an America Online™ chat room. The IM application opens upon clicking the IM application open button 74, thus allowing the user to participate in an IM conversation, such as by reading and/or entering text messages to or from a character. A special features application opens upon clicking the special features application open button 76, thus allowing the user to take advantage of various possibilities within the storyline. For example, the special features application may allow the user to cause various occurrences within the story, such as “Cause Joe to get pick pocketed,” “Cause Lucy to gamble away $1000,” or “Cause Charlie to show up at work in his underwear.” Such features may be available throughout the story, or may change as the story progresses. Further, the number of available features may change throughout the story, and some may be capable of being repeated. When the user clicks on one of the features, she is actually causing a change (i.e., the selected change) within the story, at least to some degree. The feature may cause only a temporary, minor change in the story, just for laughs and a slight plot deviation, or may actually cause a fundamental change in the direction of the story (described more later with respect to “branching” storylines). A dictionary/translator application opens upon clicking the dictionary/translator application open button 78, thus allowing the user to translate a selected word, phrase, or abbreviation. For example, abbreviations are often used in IM conversations for efficiency, such as “ty” as “thank you.” The pager application opens upon clicking the pager application open button 80, thus allowing the user to read and/or reply to pages from characters, and possibly to page other characters. The options application opens upon clicking the options application open button 82, thus allowing the user to modify any aspects and/or features of the software program that may be modified.

Email 84 comprises an information box 86 containing information of “To,” “From,” “Subject,” and “Date/Time,” and a text box 90 containing the text of the email. Both the information box 86 and text box 90 contain profile links 88 to characters which, upon clicking, allow the user to obtain information (such as a profile, a Google™ search, or other background or relevant information) about the characters. The software may include another application, a “personal profile application” (and personal profile application open button, not shown), that allows the user to type in a character's name and will display personal, important, background, and/or relevant information about the character.

The text box 90 includes a scroll bar 92 that allows the user to scroll down in the email text where the text is more than will fit within the shown text box window. The shown email text includes a web link 94 to a web site (again, which may be real or fictional). Upon clicking the web link 94, then: a) if the web browser application is not open, it will open, and will load the indicated web site; b) if the web browser application is open and minimized, it will maximize and load the indicated web site; c) if the web browser application is open and maximized, it will load the indicated web site; d) if the web browser application is open and minimized, and the web site is already loaded, then it will maximize the application; etc.

The email text also includes a question and option set 96, which asks a question of the user (in this case, who has named herself Suzie Q) and which solicits one of three specific responses. Such an option set 96 may be utilized in a branching story, such as a “choose your own adventure,” in which the user can influence the direction of the story by making decisions throughout, as understood by one of ordinary skill in the art. A branching story is a very simple form of interactive story. In the example shown in FIG. 2, the user is solicited to provide one of three possible storyline directions by replying to the sender (Marilyn) with answers a), b), or c). The software program may be configured to allow the user to respond in any of the following ways: 1) by clicking “reply,” wherein three clickable or selectable options (corresponding to answers a), b), and c)) are shown, allowing the user to click the desired answer; 2) by clicking “reply,” typing in “a,” “b,” or “c,” and clicking “send” (not shown); 3) by clicking “reply” and actually answering Marilyn in ordinary language, such as “Marilyn, I think you should call the police . . . get him thrown injail!!”; etc. In option 3), the software may be sufficiently intelligent to understand the reply text as indicating answer c). Such intelligent software (able to translate ordinary language into computer comprehensible commands) is available today. In one embodiment, the user may, as a fourth unstated answer, click the “forward” button and forward Marilyn's message to Bill, her boss (or another character), thus causing an additional, interesting twist of events.

An advantage to the embodiment shown in FIG. 2 is that the user may actively organize and freely access (e.g., read, reread, play, etc.) any communicative entity of the story (or, if restricted by the software, only those entities that have already been opened in addition to the next entity(s), thus preventing the user from skipping ahead in the story). Thus, if the user particularly enjoyed a particular IM conversation or a particular song played on the sound/music application, he may minimize these entities and keep them readily accessible for later. Another advantage is that the screen shot 52 in FIG. 2 appears more like a typical actual computer screen shot, with available application open buttons at the bottom of the screen and minimized applications/programs directly above. The embodiment shown in FIG. 2 is more realistic and personalizable.

Referring now to FIG. 3, some of the additional possible embodiments of the present invention will be explained. An introductory screen shot 202 includes a first question and answer set 204, a second question and answer set 206, a third question and answer set 208, a fourth question and answer set 210, and a fifth question and answer set 212.

The first Q/A set 204 assumes that the user may not be a voyeur. In explaining the embodiment in FIG. 1, a simple non-interactive voyeur example was given in which the user is a voyeur to (i.e., somehow has access to and reads all of) the emails and/or other communicative entities of the characters in the story, and the user also cannot interact with the characters or cause changes or make decisions in a branching plot. Such is an electronic “email” example of the traditional epistolary novel, which is typically a compilation of written letters between characters. However, unless the reader/user is willing to suspend disbelief as to how she obtained these private letters or emails, the story may not be very believable. To increase believability, in one embodiment of the present invention, the user is a friend to one or more of the characters, or is somehow believably privy to certain conversations (email, IM, chat, etc.). For example, the user may be a “friend” of Charlie and Lucy, both characters in the story, and therefore may be believably privy to conversations of Charlie and Lucy and/or information and perspectives that they provide. For example, Lucy may “email” the user several times per day, providing an update on what is going on in the story. She may do so in one or more of the following ways: writing in her own words; providing links or other attachments (as previously discussed), that help to further the story; forwarding the user emails, IM conversations, chat room conversations, voicemails, and so forth, of other characters. For example, Lucy may “email” to the user text such as the following:

Jenny [the user] . . . oh my gosh . . . after my boss left the office yesterday, I took a look at his history cache, and look at the websites he was browsing . . . www.hotcoeds.com!! Oh yeah, and you'll never believe who IMed me last night . . . . Jim!! I thought it was so funny so I copied our conversation and posted it below.

| | |
|---|---|
| RegularJim123: | heyyyyy lucy . . . whats up |
| LuckyLucy: | what do you want jim |
| RegularJim123: | im off probation in three weeks, |
| | just thinkin we could hit vegas |
| LuckyLucy: | no wayyyy |

Anyway . . . i'll keep you posted . . . i wonder if I should take him up on the offer? have a great day and I′ll email you a little later.
Lucy
PS Here's a webcam video of my little Timmy . . . click here

Even in a non-interactive version of the invention, the above embodiment has a different storytelling “feel” than a voyeur version.

The friend storytelling version described above may be presented via emails (and/or other communicative entities) provided to the user via one or more characters, such as by being the user's “friends.” For example, the story may be told to the user as if both Charlie and Lucy are the user's friends, and are both willing to email the user and provide forwards, links, attachments, and so forth, that further the storyline.

In another embodiment, the “same” story may be told from fundamentally different perspectives from different characters or groups of characters. For example, the story told to a friend of Charlie and Lucy may be different in feel and perspective (but the same in substance) as that told to a friend of Jim and Marilyn, or even of Joe, Suzie, and Charlie. Therefore, in one embodiment, the user may select in second Q/A set 206 whose friend she wishes to be. Each set (e.g., Charlie and Lucy) available for the user's choosing provides the minimum amount of information to the user that the storyteller wishes to provide to tell the story. Said another way, the emails, forwards, etc., provided only by Charlie would not sufficiently tell the story. However, emails and forwards from Lucy would fill in the gaps. Alternatively, emails and forwards from both Joe and Suzie would fill in the gaps, and so forth. Thus, the user in second Q/A set 206 is prompted to choose one set of characters with whom the user will be friends (and thus to whose conversations and information the user will be privy). Such a set of characters need not comprise more than one character, but probably comprises more than one.

In third Q/A set 208, the user is prompted to choose any additional character(s) with whom the user would like to be “friends”—i.e., to gain more information, emails, and so forth. Because much of the information will repeat itself (albeit from different character perspectives), the user may want to be discretionary in choosing additional character “friends.”

Referring back to first Q/A set 204, the user may choose whether the be a friend of one or more characters (as described with reference to second and third Q/A sets 206, 208), or to actually be one of the characters. In a non-interactive version, the user can “be” a character (such as Charlie) in the sense that all emails and other communicative entities will address and treat the user as Charlie. The user may read emails and other communicative entities before they are “sent” to the other characters (even if the user is not actually authoring the communicative entities), or the user may be able to read them only in each character's “reply” email, where the reply email includes a copy of the “sent” email. As understood by one of ordinary skill in the art, being told an epistolary story from the standpoint of one of the characters (whether minor or major) has an entirely different storytelling feel compared to the standpoint of a friend of a character or a voyeur. The user can choose in first Q/A set 204 to be told the story from the perspective of one of the characters, or a friend. If the latter, then the user is prompted with second and third Q/A sets 206, 208, otherwise the user is immediately prompted with fourth Q/A set 210.

In fourth Q/A set 210, the user is prompted to select whether to be told the story in “real-time” or as a “click-through.” In the former case, the appropriate (i.e., consistent with the user's selection as being one of the characters of a friend of one or more of the characters in first, second, and third Q/A sets 204, 206, 208) communicative entities are presented to the user at various times, such as in chronological order. For example, for emails A, B, and C, where A is sent on Tuesday at 8 am, B is sent on Tuesday at 4 pm, and C is sent on Wednesday at 9 am, only emails A will appear in the user's “inbox” (e.g., email list window 54 in FIG. 2), and thus be accessible for reading by the user, on Tuesday at 10 am, and only emails A and B will appear in the user's “inbox” on Wednesday at 8 am, and so forth. Of course, the “Tuesday” in the story may not be the same “Tuesday” in which the user has access to the emails. As another example, the software program may be configured to adjust all dates and times of sent emails depending on when the user installs and runs the software program for the first time. For example, email A may be “sent” immediately to the user upon first running the software program, and the software program may be configured to “send” email B to the user exactly 47 minutes after first running the software program, and so forth, so that the emails are “spaced out” (in terms of accessibility to the user) in real time in a realistic fashion. The time spacing between such emails (and/or other communicative entities) need not be great; they may be spaced out by a few minutes each, so as to give a more realistic feel to the storytelling, without the need for the user to wait hours or days between such communicative entities. In any event, the “real-time” version of the invention simply refers to a time spacing of delivery to the user of at least some of the communicative entities that at least partially emulates a time spacing of communicative entities received by a person in real life, so as to make the storytelling more believable. For example, in the real-time version, the user (having the software program open and running on her computer) may have opened and perceived all communicative entities, and may simply be waiting for another entity, when an IM “pops up” on her computer screen within the program's window, which is a new communicative entity for her to read, enjoy, and which furthers the plot. She could reply to the IM (in an interactive version), or just read it as other characters type (in a non-interactive version). The IM may appear “randomly” from a minor or an as-of-ye unintroduced character. Of course, the entity could be an unopened email that “pops up” in her email list window, or a voicemail or pager message that pops up on her computer screen, etc. After perceiving the entity (and interacting to the extent possible and to her liking), she must wait for another communicative entity to become available to perceive.

The antithesis of the real-time version is the “click-through” version, in which the user is presented, after running the software program for the first time, with all communicative entities. The user may then click through each entry in a listing of such communicative entities until the story has been fully told. The entities are read (heard, seen, etc., depending on the type of entity) at the user's own pace, and the user may simply click on the next entity when she is finished perceiving the previous entity. The software may allow the user to skip around to perceive any entity at any time, or may limit the user to a particular order (and may or may not allow the user to perceive already perceived entities). In this embodiment, the software may also include a bookmark feature that allows the user to close the software program, and upon re-running the software program at a later time, the bookmark feature starts the story (by presenting the relevant communicative entity) at the point at which the user bookmarked and closed the program.

In fifth Q/A set 212, the user is prompted for his name and email address, if the user has not opted to be one of the characters in first Q/A set 204. The name and email address may be real or fictitious, but will be used by the software program as the recipient of the user's emails (e.g., appearing in the information box 86 (FIG. 2) of emails) and other entities.

Referring now to FIGS. 4a and 4b, a particular screen shot 252 includes an email list window 254 and an IM conversation window 256 including an IM conversation 258, a scroll bar 260, an IM text entrance box 262, a new IM button 264, and an IM reply button 266. The text written in the IM text entrance box 262 was written by Joe (whose IM screen name is CheatingJoe), a character in the story, which may have been written by the user (if the shown embodiment represents an interactive version in which the user has elected to be Joe). In one embodiment, the text of the IM conversation 258 is shown typed in “real-time,” as the characters represented by CheatingJoe and CutieCoed7 “type” their messages. For example, while in one embodiment the entire IM conversation 258 is shown all at once, allowing the user to scroll down through and read the conversation, in another embodiment, the sentences/entries are displayed as a whole, but one at a time (not all at once), such as in chronological order, and are timed corresponding to when each fictitious character “presses” “enter” to send the IM (as understood by one of ordinary skill in the art). In another embodiment, the actual “typing” of each character is shown to the user, either in the text of the IM conversation 258, and/or in the IM text entrance box 262. For example, in FIG. 4a, the software may show the typing out by CheatingJoe of “got a pic of you in your swimsuit,” thus showing any deletions, changes, spelling/grammar corrections, hesitations, and so forth, in Joe's typing of the IM. In FIG. 4a, Joe has not yet sent the IM that he just typed in the IM text entrance box 262. After hesitating for a moment, he decides that he will have more luck with the character represented by CutieCoed7 by asking her about Sartre, and thus deletes what he has written in the IM text entrance box 262 and writes (and ultimately sends) a new IM shown in IM text entrance box 262′ of IM conversation window 256′ in FIG. 4b. An advantage to such a feature is that a great deal of information can be gleaned about a character by witnessing the mental processes of that character in writing to or otherwise interacting with another character.

Several variations on the above described embodiments will now be described.

First, the present invention is not constrained by traditional methods of storytelling, in which a story is told (e.g., via a novel) with the same details from start to finish, independent of the desires or interests of the reader. In one embodiment, the software program includes far more communicative entities than are necessary to satisfactorily tell the story. While the user could simply click through all emails (and/or other communicative entities) in chronological order (or other order suggested by the software program), the software program includes lots of other “optional” communicative entities that the user may perceive and enjoy, and which may: enhance the enjoyment of the story by providing, e.g., comic relief; provide additional facts, clues, and other relevant information; provide differing insights or perspectives; and so forth. For example, in one embodiment, the entire story is sufficiently told via a sequence of emails and IM conversations. However, the user may open a chat window (e.g., by clicking on the chat room application open button 72 in FIG. 2), where the user may perceive two or more characters chatting about either relevant or irrelevant subjects. For example, in the former case, where the story being told is a suspense thriller, the conversation might be between involved characters as to who they think committed the crime, what facts they have witnessed, and what they intend to do, etc. In the latter case, the conversation might be just a silly and funny (albeit largely irrelevant) conversation that provides a comic relief. Of course, any other conversation that enhances the pleasure of the user is within the scope of the invention, such as conversations regarding art, music, health, politics, sex, news, pop culture, and so forth, and is not limited to humor.

Further, the optional communicative entities are not limited to chat rooms. For example, at any time, the user may email a particular character, designated as a funny character, who will reply with a joke or funny anecdote. Or the user may at any time write an IM to the funny character, who will reply with jokes or funny stories, etc. Again, these optional communicative entities are not limited to humor, and they are not limited in medium to IMs or emails—i.e., any communicative entity medium may be used for this purpose.

Next, while the invention has thus far been described largely as non-interactive, the invention also encompasses interactive versions (e.g., in which the user can actually interact (e.g., with characters or with the software program itself) in a manner that causes meaningful changes to the told story and/or how the story is told). A story may be made interactive in at least one of four ways, in addition to possible combinations: a) choose-your-own-adventure; b) information seeking; c) cause-and-effect; and d) being a character. Version a) is a sort of “branching” story-however, other versions (such as versions c) and d)) may also be branching without being choose-your-own-adventure. In version a), the user is occasionally prompted to make a decision about the direction of a story. The user may not know the outcome or consequences of the decision-but that's what makes it fun and interesting. One example of version a) is shown and described with respect to FIG. 2, in which the user is prompted to respond to question and option set 96. The story “branches” at this point into up to three different results/consequences, and the next event(s) in the plot depends on the user's response. Of course, the software may be programmed to recognize the user's response only where she has typed “a,” “b,” or “c,” or the user may choose which of several pre-written emails to send back to the sender, or the software may be more intelligent and capable of translating an email “reply” from the user as an appropriate response. Further, the user may have other options besides those explicitly offered. In the example shown in FIG. 2, another option (which the user may not know about a priori, but may figure out through trial and error and/or experimentation within the program) might be to reply to Marilyn and suggest that Marilyn purchase some heroine from her boss, Bill. If the software program is configured to accept that as a valid response, then the story may actually branch into four (or even more) story branches at that point. The story may include only a few branching points (i.e., question and option sets), or may include several dozen, or even more than one hundred. The number is limited only by the complexity of the software and the imagination of the storyteller.

In version b), the information offered in the “obvious” communicative entities is insufficient to fully tell the story. (By “obvious” is meant that little or no work is necessary to find these entities.) For example, referring back to FIG. 2, the email list window 54 may contain only a dozen (or other small number of) emails, enough to introduce some of the main characters and provide a setting. To be told the whole story, the user must actively seek information, such as by writing emails to characters and asking questions, or writing IMs to characters asking questions, entering chat rooms, surfing the (fictitious) web, and so forth. The user may be limited in the questions it may ask, or the form of the questions, because of software translation limitations. (However, as this technology progresses, it won't much limit the range of ways in which the user may seek information by writing statements or questions in ordinary language.) As the user asks questions of characters and they respond, the user obtains more information about events, other characters, and so forth, about which he may ask further questions and seek further information, and so forth. Thus the story unfolds as the user actively seeks information. The user may be a “friend” of one or more of the characters, who write emails/IMs/etc. to the user, and to which the user may reply and/or ask questions. The software program may limit questions to topics mentioned in the emails to which the user is replying, or the software program may be more intelligent and allow the user to ask a wide variety of questions on a wide variety of topics to various characters.

In version c), the user can cause changes in the story at times other than pre-designated branching points, and is thus more versatile than version a). One example of version c) is the special features application described with respect to FIG. 2, in which the user may cause one or more interesting events to occur. Upon pressing the special features application open button 76, the user is presented with one or more various causes that she may effect, which may fundamentally or only superficially modify or branch the storyline. The causes may be silly, humorous, fun, violent, sexual, etc., depending on the nature of the story—a couple of which have been suggested with reference to FIG. 2. Other ways of implementing version c) are by allowing the user to forward one character's email to another character, allowing the user to email/IM/etc. other characters and suggest actions, and so forth.

In version d), the user actually acts as one of the characters. (This is to be contrasted with “being” a character in terms of perspective in a non-interactive version.) In this version, which is more versatile and interactive than version c), the user can do more than a short list of possible, predetermined actions—rather, the user can fundamentally direct the story. For example, the user can create a murder suspense by murdering (in the software program, of course) another character, and so forth. This version is another example of a branching story, except that the number of branching points and the number of possible branches per branching point may be very, very large, thus requiring sophisticated software and the hard work of many creative authors. In version d), the user may select which character he wants to be (e.g., in a story having a predetermined set of characters and a relatively predetermined plot that can and should be modified by the user), or the user may select only which kind of character he wants to be (e.g., what attributes, features, etc., the character possesses).

Next, in one embodiment, the communicative entities may be sorted in one or more of many ways (such as via the “options” application, described with respect to FIG. 2), such as chronology, reverse chronology, character, sender, receiver, subject, date, time, whether the entity includes links and/or attachments, the type of entity (e.g., voicemail, IM, etc.), and searchable terms (described with reference to FIG. 1). This sorting feature may apply to both the aforementioned software program (“Readerware”) or a program in which a user writes a digital epistolary novel according to the present invention (“Writerware,” described later). In other words, in the Writerware, a user may draft communicate entities by chronology, character, subject, and so forth. Further, entities may be sorted according to their branch location(s). For example, the user may be able to see the actual branch structure of the story, and to sort or select only those entities in a particular branch, and so forth.

Next, any communicative entity may contain a link to any other communicative entity, and/or may contain any communicative entity as an attachment. For example, an IM may contain a link to a song (playable on the sound/music application, with reference to FIG. 2), a website (viewable on the web browser), an email (viewable via the email application), and so forth.

Next, a branching version of the present invention need not be interactive, and/or one or more branching points in the story may not be determined or chosen by the user. They could, for example, be random. An advantage to this feature is that the story told to each user may be different from that told to every other user. Of course, one or more branching points may be determined by the user, so that some of the story is “deterministically” chosen by the user, while some of the story is “randomly” chosen by the computer on which the software program is running. This feature is not limited to randomly determined branches—i.e., branches may be chosen by the computer in other ways besides randomly (such as based on features of the character that the user opted to “be,” based on the season, date, and/or time that the software program is being run, based on other information provided by the user, etc.).

Next, the present invention need not apply to a software program run on a conventional personal computer (PC). For example, the story could be told in a series of messages sent remotely to a user's cellular phone or communications device (such as a Blackberry™ email communication device). As another example, a simpler version of the software could be loaded into a conventional personal digital assistant (e.g., Palm Pilot™), thus “delivering” emails to the user on a regular basis (real-time) or all at once (click-through) to allow the user to read the digital epistolary novel.

Next, the present invention includes a method of profiting by obtaining sponsorship of one or more aspects of the software program. For example, advertisements may be placed throughout the software program and/or story told in any of the following variations: product placement (e.g., a character using or describing a particular product); explicit advertising (e.g., a banner ad in the program's background); and endorsement (e.g., where the sound/music application is a digital replica of an Apple iPod™). Any other means for profiting by obtaining sponsorship known in the art is within the scope of the present invention.

Next, the software program may include one or more quizzes (or quiz question sets) throughout the story, which may appear at the end of predetermined sections of the story. The quizzes may include questions like, “Why did Joe decide to cheat on his fiancee?” “Who is Lucy's other lover?” “Is Bill being framed as a heroine dealer?” and “What went wrong with the company's management?” The purpose of these questions sets may be wholly for fun, to test the user's reading comprehension, to allow the user to go or return to other communicative entities in case the user has missed important details or facts, or to help educate (more discussed later). The questions could be written in a way that mimics how Sherlock Holmes quizzes Dr. Watson regarding details and the storyline. Further, the aforementioned sorting feature may allow the user to sort through quizzes, quiz questions, and/or quiz answers.

The present invention includes a method of storytelling, a method of teaching, software (Readerware) implementing any of the discussed methods, and software (Writerware) implementing any of the discussed methods. Regarding the method of teaching, teachers often use stories and novels to educate children (or anyone, such as adults learning a foreign language). The present invention includes the use of the described methods and software to teach a person, with the recognition that the storytelling methods described herein are interesting, thought-provoking, and novel, and are told using familiar communicative entities commonly used by children and young adults today (e.g., email).

Next, the software may not be fully self-contained, and may require an Internet connection to download actual world wide web pages, to send and receive actual emails, and so forth. Further, the software program may include a story that, via the real Internet connection, is interactive story with another real person. For example, two (or more) users, remotely connected via the Internet, may each act as different characters (and/or friends of characters, as discussed), and may each individually interact with the software in the ways previously discussed, but may also interact with each other via emails, IMs, and so forth, to share information.

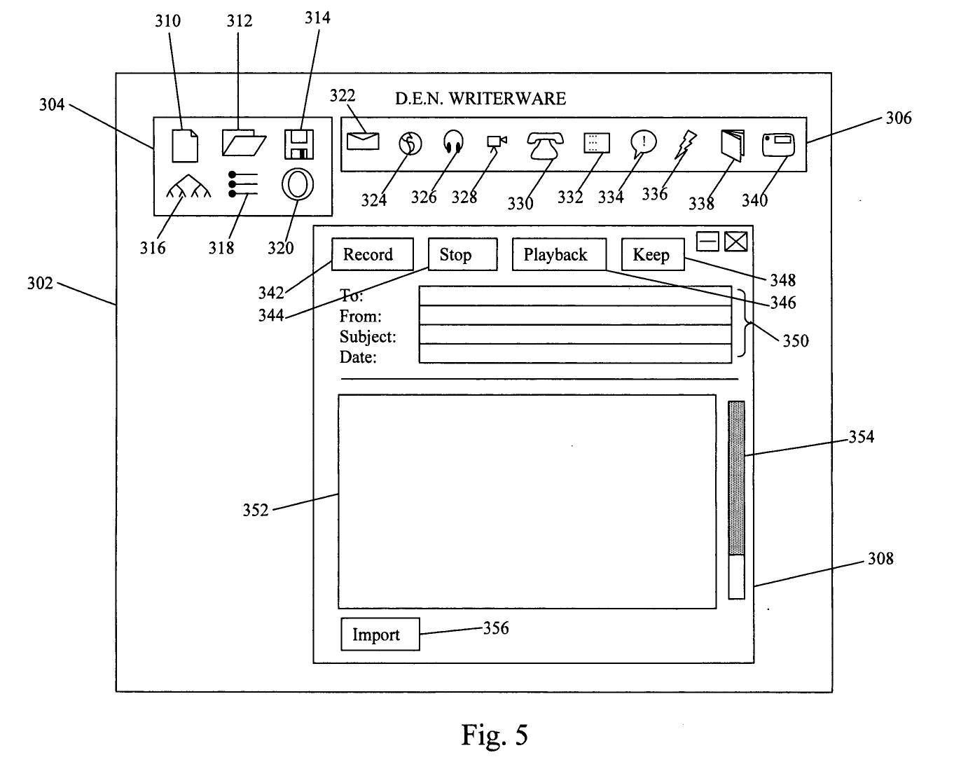

Referring now to FIG. 5, an embodiment of the Writerware according to an embodiment of the invention will be explained. A computer screen shot 302 comprises an application menu 304, an entity menu 306, and an entity recorder window 308. The application menu 304 comprises a new icon 310, an open icon 312, a save icon 314, a tree/branch icon 316, an entity list icon 318, and an options icon 320. Clicking the new icon 310 starts a new project; clicking the open icon 312 opens an existing project; clicking the save icon 314 saves the current project. Clicking the tree/branch icon 316 opens a tree/branch application (not shown) that shows the tree and all existing branch features of the current branching storyline, such as location on the tree of each communicative entity, the type(s) of entity, the filenames of entities, file sizes, date modified, and so forth. The tree/branch application also allows the user to cut, paste, move, “drag,” edit, and modify existing entities, such as by clicking on the relevant entity with a mouse to cut, paste, and move, and double clicking on the relevant entity to edit and modify entities, as understood by one of ordinary skill in the art. The tree/branch application also allows the user to insert newly created entities at designated locations on the tree, as well as to create new branches and branching points. Clicking the entity list icon 318 opens an entity list application that lists all existing entities (not shown). Like the tree/branch application, the entity list application allows the user to cut, paste, move, drag, edit, modify, and insert communicative entities. Clicking the options icon 320 opens an options application that allows the user to adjust features of the software program that are adjustable in the options application, such as those mentioned with respect to options application open button 82 in FIG. 2.

The entity menu 306 comprises a listing of all available communicative entities, as well as other features, and includes an new email icon 322, a new website icon 324, a new sound/music entity icon 326, a new video entity icon 328, a new voicemail icon 330, a new chat room conversation icon 332, a new IM conversation icon 334, a new special features icon 336, a new dictionary/translator icon 338, and a new pager entity icon 340. In a project, a user may click on one of the above icons to generate a new communicative entity or special feature, in the creation of a digital epistolary novel or other project within the scope of the present invention.

An example will be given with respect to the entity recorder window 308, which is shown in FIG. 5 configured for creating a new email. The entity recorder window 308 may have appeared after the user, in an open project, clicked the new email icon 322. The entity recorder window 308 comprises a record button 342, a stop button 344, a playback button 346, a keep button 348, an information entrance box 350, a text entrance box 352, a scroll bar 354, and an import button 356. The user enters the relevant information into the information entrance box 350, such as who the email will be sent to (“To”), who it will be sent from (“From”), as well as the subject (“Subject”) and date and time (“Date/Time”). Then, when the user is ready to write the email, she clicks the record button 342 and composes the email in the text entrance box 352. She should act as if the writing were a performance-because it is. The way a person types—e.g., how fast, how accurately, erasures, hesitations, spelling/grammar mistakes, etc.—is very telling of the person. When the email is completed, the user can click the stop button 344, and she can play her recording by clicking the playback button 346. If she is unhappy with the performance, she can re-record by clicking the record button 342 again, or she can keep the performance by clicking the keep button 348. After keeping the entity, she can save the entity and give it a filename, so that the entity may be readily moved around, edited, and so forth in one of the applications 316, 318. If she wants to include a link and/or attachment (e.g., sound file, video file, etc.) to the email, she can click the import button 356 to import the appropriate link and/or file (which may be located on her computer, on the Internet, or internally to the software, such as “clipart”).

Of course, in an embodiment of the invention in which the typing of emails/IMs/etc. is not shown during “playback” or viewing of the story in the Readerware, there may be no need for the buttons 342, 344, and 346. Rather, a user could just click on the appropriate icon (e.g., new IM conversation icon 334), draft an IM conversation between characters, and save the conversation using a filename so that the conversation can be readily moved, edited, etc. within one of the applications 316, 318.

Other applications in the Writerware are possible, such as a sort option (which may be in the options application) that allows the author to organize entities according to character, chronology, etc. One advantage to this feature is that an author can write one character's side of a dialogue at a time, instead of writing a whole conversation in chronological order. Further, a writer could write the ending dialogue first, or could write the dialogue for the climax first, etc., and the later “drag and drop” the entities at the appropriate place in the storyline using the entity list icon 318.

Variations of the above described embodiments are within the scope of the present invention. For example, in one variation of the embodiment shown in FIG. 2, the screen shot includes a primary email list window that always remains open, with other features and/or applications available as pop-up windows that can be opened by clicking on corresponding open buttons.

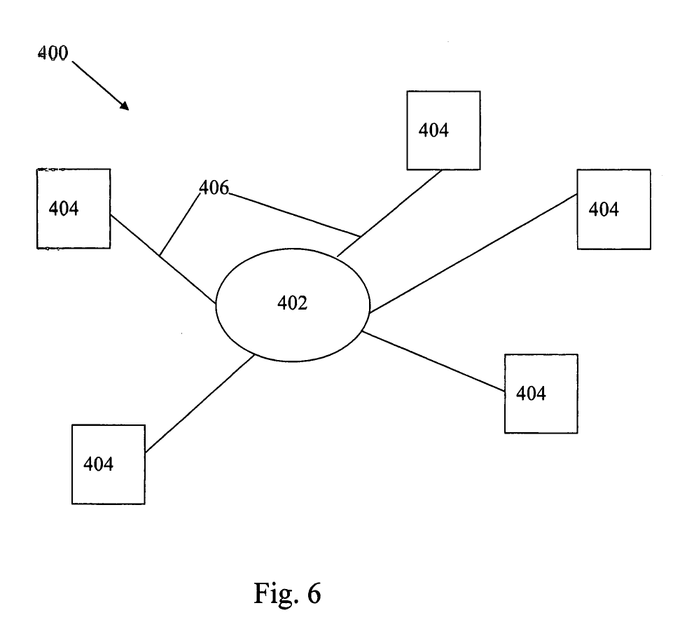

Referring now to FIG. 6, a computer network 400 comprises a central processor 402 and a plurality of remote processors 404 remotely connected to the central processor 402 via information lines 406.

1.-60. (canceled)

61. A method of relaying to a user an account regarding characters, the account comprising one embodiment of a branching story, comprising:
generating a plurality of electronic communicative entities, each of the communicative entities expressing a communication of at least one character;
displaying the electronic communicative entities to the user;
prompting the user to choose a branch among a plurality of branches of the branching story;
receiving a branch choice of the user; and
relaying the account to the user based at least in part on the branch choice,
wherein each of a majority of the electronic communicative entities comprises at least one of an email, an instant message, a chat room message, and a web page, and
wherein the account is substantially completely relayed to the user by the plurality of electronic communicative entities.

62. The method as claimed in claim 61, wherein the displaying comprises displaying each of the electronic communicative entities to the user in applications corresponding to the type of entities, and wherein the applications comprise at least an email application, an instant message application, and a web browser application.

63. The method as claimed in claim 61, wherein at least two embodiments of the branching story are substantially different.

64. The method as claimed in claim 61, wherein no two embodiments of the branching story are substantially different.

65. The method as claimed in claim 61, wherein the method further comprises:
prompting a second user to choose a branch among a plurality of branches of the branching story;
receiving a branch choice of the second user; and
relaying the account to the user and second user based at least in part on the branch choice of the second user.

66. The method as claimed in claim 61, wherein prompting the user to choose the branch comprises prompting the user to draft and address an electronic communicative entity to at least one of the first and second characters, the electronic communicative entity comprising at least one of an email, an instant message, and a chat room message.

67. The method as claimed in claim 61, wherein for each branch, the user is prompted to choose the each branch at a specified point in a timeline of the account.

68. The method as claimed in claim 61, wherein for at least one branch, the user is prompted to choose the at least one branch at a plurality of points in a timeline of the account.

69. A computer-readable medium encoding computer-executable instructions for performing the method as claimed in claim 61.

70. A method of relaying to a user an account regarding at least first and second characters, comprising:
prompting the user to choose to perceive the account from the perspective of at least one of the first character, the second character, a friend of the first character, and a friend of the second character;
receiving a choice of the user; and
relaying the account to the user based at least in part on the choice of the user,
wherein the account is substantially completely relayed to the user via a plurality of electronic communicative entities, and
wherein each of a majority of the electronic communicative entities comprises at least one of an email, an instant message, a chat room message, and a web page.

71. The method as claimed in claim 70, wherein if the user chooses to perceive the account from the perspective of a friend of the first or second character, the method further comprises:
providing the user with a list of sets of characters;
prompting the user to choose at least one of the sets of characters;
receiving a choice of the user; and
relaying the account to the user based at least in part on the choice of the user of at least one of the sets of characters,
wherein for each of the sets of characters, that portion of the account relayed to the user from the perspective of friends of the characters in the each of the sets of characters comprises substantially a whole of the account.

72. The method as claimed in claim 70, wherein if the user chooses to perceive the account from the perspective of a friend of the first or second character, the method further comprises:
prompting the user to choose at least another character;
receiving a choice of the user; and
relaying the account to the user based at least in part on the choice of the user of at least another character.

73. The method as claimed in claim 70, wherein the method is noninteractive, whereby neither the account nor the manner in which the account is relayed to the user is substantially affected by any action of the user.

74. A computer-readable medium encoding computer-executable instructions for performing the method as claimed in claim 70.

75. A method of creating an account regarding characters, comprising:
providing an electronic template for entering information;
prompting a user to compose a plurality of electronic communicative entities and to enter the electronic communicative entities via the template, each electronic communicative entity representing an electronic communication from one of the characters to at least one other of the characters; and
prompting the user to arrange the plurality of electronic communicative entities in an order,
wherein each of a majority of the electronic communicative entities represents at least one of an email, an instant message, and a chat room message, and
wherein the account can be substantially completely relayed to a reader by displaying to the reader the plurality of electronic communicative entities in the order.

76. The method as claimed in claim 75, further comprising:
for each electronic communicative entity, prompting the user to select whether the electronic communicative entity represents an email, an instant message, or a chat room message.

77. The method as claimed in claim 75, further comprising:
prompting the user to create a plurality of branches, whereby the account comprises one embodiment of a branching story;
for each electronic communicative entity, prompting the user to assign the electronic communicative entity to at least one of the plurality of branches.

78. The method as claimed in claim 75, further comprising:
for each electronic communicative entity, prompting the user to determine whether or not displaying of the electronic communicative entity to the reader requires an action of the reader.

79. The method as claimed in claim 75, further comprising:
prompting the user to indicate character perspective options, whereby the account may be relayed from the perspectives of at least two different characters; and
for each electronic communicative entity, prompting the user to assign the electronic communicative entity to at least one character perspective option.

80. A computer-readable medium encoding computer-executable instructions for performing the method as claimed in claim 75.
